(19) United States
(12) Patent Application Publication
(10) Pub. No.: US 2006/0249437 A1
(43) Pub. Date: Nov. 9, 2006

(54) Folder device, delivery point package and method of use

(76) Inventor: Lance E. Anderson, St. Paul, MN (US)

Correspondence Address: DOUGLAS L. TSCHIDA, 633 LARPENTEUR AVE. WEST, SUITE B, ST. PAUL, MN, 55113, US

(21) Appl. No.: 11/396,965

(22) Filed: Apr. 3, 2006

Related U.S. Application Data
(63) Continuation-in-part of application No. 10/004,595, filed on Dec. 5, 2001, now abandoned.
(60) Provisional application No. 60/251,363, filed on Dec. 5, 2000.

(51) Int. Cl. B07C 7/04

(52) U.S. Cl. 209/703

(57) ABSTRACT

The present invention relates to a folder device and method of use in conjunction with a sorting device. The sorting device for use with the folder device may assume a variety of configurations. The present invention provides a folder device for receiving items for use with a sorting device. In one embodiment a first side of the folder is configured in relation to the leading edge of its associated partition element so that at least a portion of the first side does not extend vertically past the leading edge. The present invention further provides a method of creating a delivery point package. The delivery point package may facilitate the delivery of mail items by providing a discrete package by capturing items between the folder sides.

### RELATED APPLICATIONS

This is a continuation-in-part of co-pending application Ser. No. 10/004,595, filed Dec. 5, 2001 and also of provisional application Ser. No. 60/251,363, filed Dec. 5, 2000.

### FIELD OF THE INVENTION

The present invention is directed to a folder for use in conjunction with a device for sorting documents, preparing postal delivery point packages and more particularly directed to a sorting folder and method for use with a sorting device such as disclosed in U.S. Pat. No. 6,341,700. Additionally, the present invention is directed to a folder and method of use of the folder for preparing delivery point packaging of mail in an automated or manual mail sorting and delivery operation.

### BACKGROUND OF THE INVENTION

Devices for sorting documents, such as mail and the like, are known. Sorting devices may be manual devices by which a human sorter places documents in corresponding slots or other document sorting structures. Additionally, automated sorting devices are known wherein the sorting process is handled under computer or electronic controller direction. In an automated process, information associated with the individual item is read via an optical or magnetic means and utilized to control the ultimate destination of the item in a sorted order. Based on mail type and address quality both methods of sequencing letters into delivery order are utilized by mail delivery institutions resulting in multiple stacks (streams) of sequenced mail that must be collated together before delivery. A need exists for a device and method of efficiently capturing all types of sorted mail associated with a predetermined address into a delivery point package that can be easily identified and accessed by the delivery person while on the route.

One manual sorting device is disclosed in U.S. Pat. 6,341,700, issued to Soderstrom, and incorporated by reference herein. The Soderstrom device relates to sorting documents, mail and the like, which device is designed for arranging the documents into an ordered collection such that multiple groups are ordered in a delivery sequence that facilitates some later process such as delivery of document or mail groups. In post offices, in mail departments of companies, institutions, government agencies and the like, there is a need for an efficient approach to handling large quantities of mail. The Soderstrom device addresses a need for efficiently processing items of mail or other documents so that the items may be distributed to the addressee in a labor-saving way.

However, the Soderstrom device is not without limitations. For example, relatively light items placed within the partitions of the device may in some circumstances be separated from associated mail during a controlled fall process. In this regard, the separated items need to be manually reinserted in correct association with the sorted mail. Additionally, it would be desirable to efficiently capture machine and/or manual pre-sorted items into a delivery point package for subsequent delivery. An efficiency of the present folder and sorting methodology is to prepare delivery point packages that accommodate the full range of possible mailing items that because of their shape or address quality may have been sequenced into delivery ordered groups using a variety of manual or automated sorting methods. For example, the latter pre-sequenced mail items may comprise sequenced letters, sequenced flats, residual flats, residual letters, among others. The folder and method also accommodate the additional insertion and combination of mailed items up to the time of actual delivery, such as when a carrier combines previously sorted and/or saturation items from other containers into the folders of the present invention.

### SUMMARY OF THE INVENTION

The present invention relates to a folder device for use in conjunction with a sorting device and a method of preparing delivery point packages accommodating all types of mail (e.g. flats and letters, other than packages) and combinations thereof for each delivery destination. The sorting device for use with the folder device may assume a variety of configurations. In one embodiment, the sorting device may be the Soderstrom device of U.S. Pat. No. 6,341,700. A sorting process with alternative sorting devices may also benefit from aspects of the present invention.

An object of the present invention is the provision of a folder device for receiving items for use with a sorting device. In one preferred embodiment, each side of the folder is associated with one of the partition elements of the sorting device. A first side of the folder is configured in relation to the leading edge of its associated partition element so that at least a portion of the first side does not extend vertically past the leading edge. At least a portion of the second side extends vertically past the leading edge of its associated partition element to facilitate an improved document sorting process.

The present invention is further related to a method of creating a delivery point package through a folder device. In particular instances, the delivery point packages may combine all types of manually and/or machine sorted mail. The delivery point package facilitate the delivery of mail items by providing a discrete delivery package that captures all mail items between the folder sides.

The method includes the steps of: sorting a plurality of mail items into mail item sub groupings, each sub-grouping including similar destination indicia; providing a plurality of invertable folder devices each folder having a pair of sides and defining at least a pair of orientations, including a first orientation wherein the sides are generally coextensive and flat with each other; placing between each sub-grouping a folder device in the first orientation (e.g. a flat, divider or inverted condition wherein the normal inside surfaces of the sides are facing out); accessing a particular sub-grouping of mail items and an associated folder device; and folding or re-inverting the folder device to a second orientation, for example, folding one side panel to capture the sub-grouping of mail items between both sides of the folder device (e.g. with both normal exterior surfaces of the folder sides facing out) to define a delivery point package.

### BRIEF DESCRIPTION OF THE DRAWINGS

FIG. 1 is a diagrammatical top view of a first embodiment of the sorting device.

FIG. 2 is a diagrammatical top view of a second embodiment of the sorting device.

FIG. 3 is a diagrammatical sectional view of the first embodiment in FIG. 1.

FIG. 4 is a perspective view of one embodiment of a folder device according to the present invention.

FIG. 5 is a perspective view of the folder of FIG. 4 situated in context with a sorting device.

FIG. 6 is a perspective view of the folder of FIG. 4 situated in context with a sorting device.

FIG. 7 is a diagrammatic view illustrating a method of use of an embodiment of the folder device according to the present invention.

FIG. 8 is a diagrammatic view illustrating an array of sorted items including USPS “flats” and folder devices in a first orientation (e.g. inverted, inside-out).

FIG. 9 is a diagrammatic view illustrating an inversion process of a folder device.

FIG. 10 is a diagrammatic view illustrating the array of sorted items of FIG. 8 disposed within a sorting device.

FIG. 11 is a diagrammatic view illustrating a delivery point package according to the present invention.

FIG. 12 is a flow chart of the current method used by the USPS to collate all possible types of mail that might be directed to a delivery destination.

FIG. 13 is a flow chart to an improved sequenced collation process including mail items collated into the folders of the invention and compatible with the Soderstrom and other available sorting cases.

### DETAILED DESCRIPTION OF THE PREFERRED EMBODIMENTS

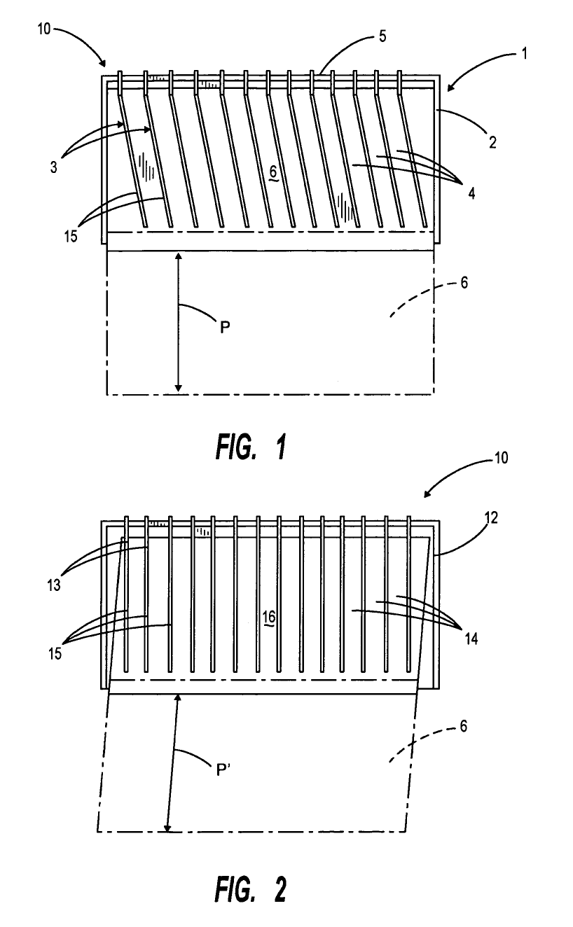

Conventional sorting cabinets for items of documents or mail comprise compartments for sorting the items in a certain order of distribution, e.g. street address or room number. The items are sorted into the compartments, and are then removed and gathered in bundles for distribution within, for example, a postal district. The Soderstrom device or case 10 aims at providing a sorting device which facilities the bundling of the sorted items by providing means for emptying the sorting compartments in such a way as to automatically bundle the items in sorted order. FIG. 1 shows, in a top plan view, an embodiment of the Soderstrom device 10 for sorting items 1 comprising a frame 2, in which partitions 3 are arranged in a spaced relationship, forming a number of compartments or sorting compartments 4. The partitions 3 are fixedly or removably arranged on the rear section or rear element 5 connected to the frame 2, the partitions extend substantially parallel with respect to each other. In the embodiment shown in FIG. 1, the partitions are bent so that, in a horizontal plane, they will extend in an oblique direction with respect to the frame 2.

Extending below the partitions 13, spaced apart from their lower edges, is a horizontal plate member which forms the bottom 6 of the sorting compartments 4. The drawer or bottom member 6 can be withdrawn from the frame in the direction of arrow P, and is displaceable with respect to the partitions 3 in a direction P which deviates from the direction in which said partitions 13 extend. The dot-dash line shows the bottom member in a withdrawn or displaced position. Slidable guide means, e.g. guide rails, not illustrated, are arranged in the frame to act as bearing means to allow for the displacement of the bottom member 6.

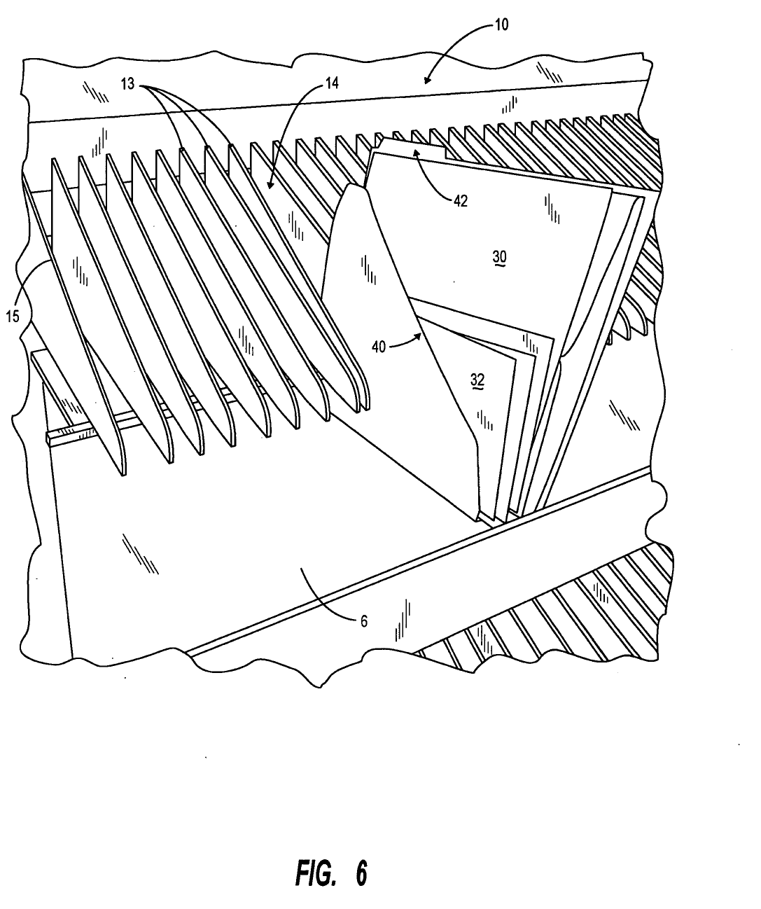

FIG. 6 illustrates the bottom member 6 partially withdrawn from the frame 2. In another embodiment (not shown), the partitions 13 are movably supported upon the frame 2 and are displaceable relative to a stationary bottom 16. In that embodiment, the partitions 13 are extended away from the stationary bottom 16 during the controlled felling operation.

FIG. 2 shows, in a view similar to that of FIG. 1, another embodiment of the Soderstrom device 10 for sorting items. The device 10 has straight partitions 13 extending mainly at right angles in relation to the frame 12, and which run parallel with respect to each other, thus forming a number of sorting compartments 14. The partitions 13 include a leading edge 15, which in this embodiment is a generally linear shape. Alternative leading edge 15 configurations would also be practicable. The partitions 13 are arranged in the frame 12 by suitable means as described above. The bottom 16 of the sorting compartments is arranged on slidable guiding means (not shown) extending obliquely with respect to the frame 10, in order to be displaced in a direction P which deviates from the general direction in which the partitions 13 extend. The dot-dash line indicates the bottom 16 withdrawn from the frame.

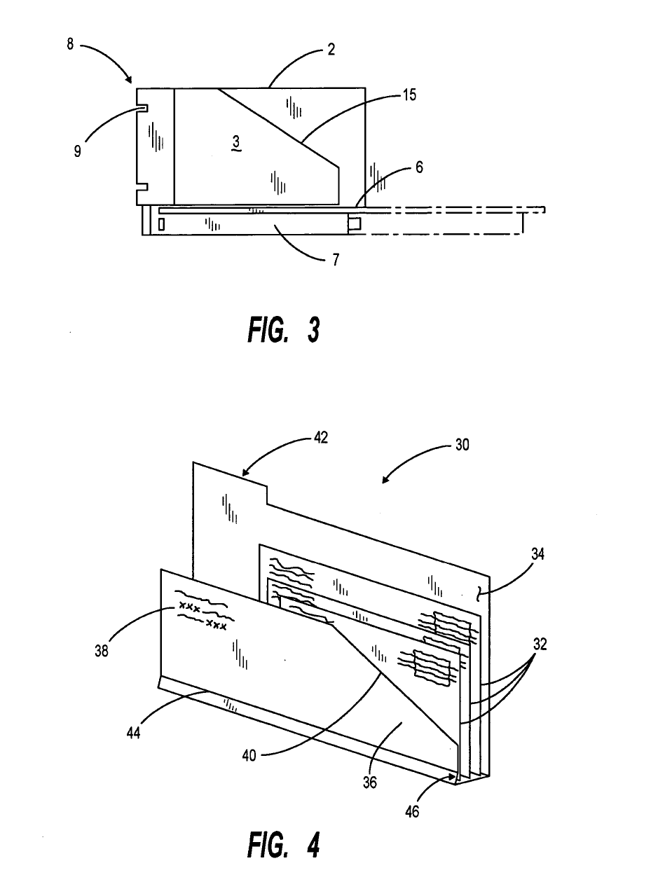

FIG. 3 shows the first embodiment in a diagrammatical cross sectional view with one of the sides of the frame broken away in order to illustrate the displaceable arrangement of the bottom member 6 on slide able guiding means 7, which guiding means are arranged at the lower edge of the side of the frame.

When documents, letters or the like are to be sorted, these are placed in the respective compartment, in accordance with the order in which they are to be distributed, in such a way that the lower edge of each item rest on the displaceable bottom 6 of the compartment. Due to the fact that the bottom 6 of the sorting device is displaceable in relation to the partitions 13, in a direction which deviates from the general direction in which said partitions extend, the items during the displacing movement of the bottom 6 fall in a controlled manner in the same direction. After the controlled fall, the items may be pushed together into bundles in correct order in an easy manner. Several embodiments of the Soderstrom device are disclosed, which all share the common feature of mutual displacement of the bottom 6 and the partitions 13 in a direction which deviates from the general direction in which the partitions 13 extend, through which displacing movement is achieved the controlled felling of the sorted items in a common direction.

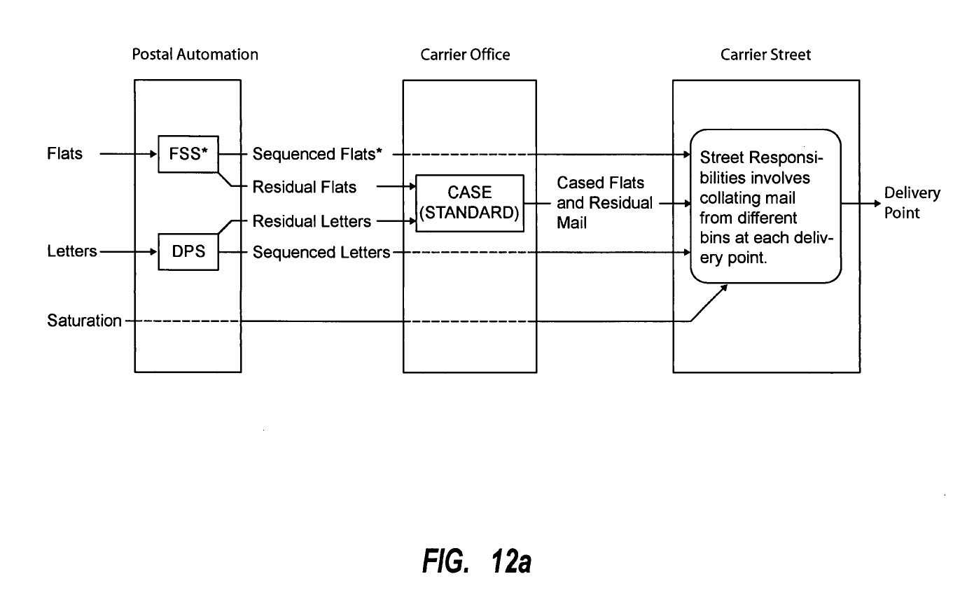

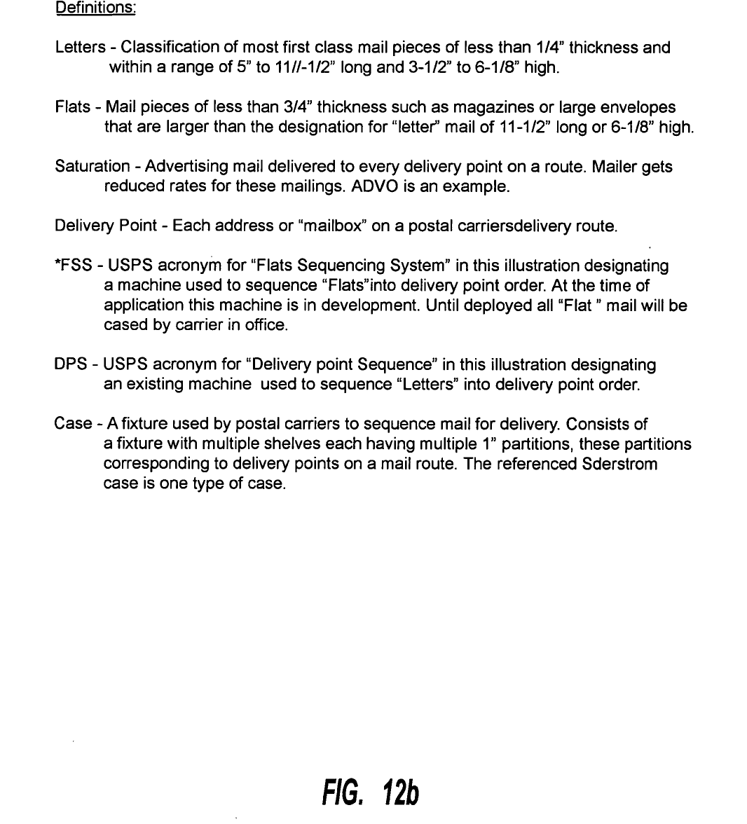

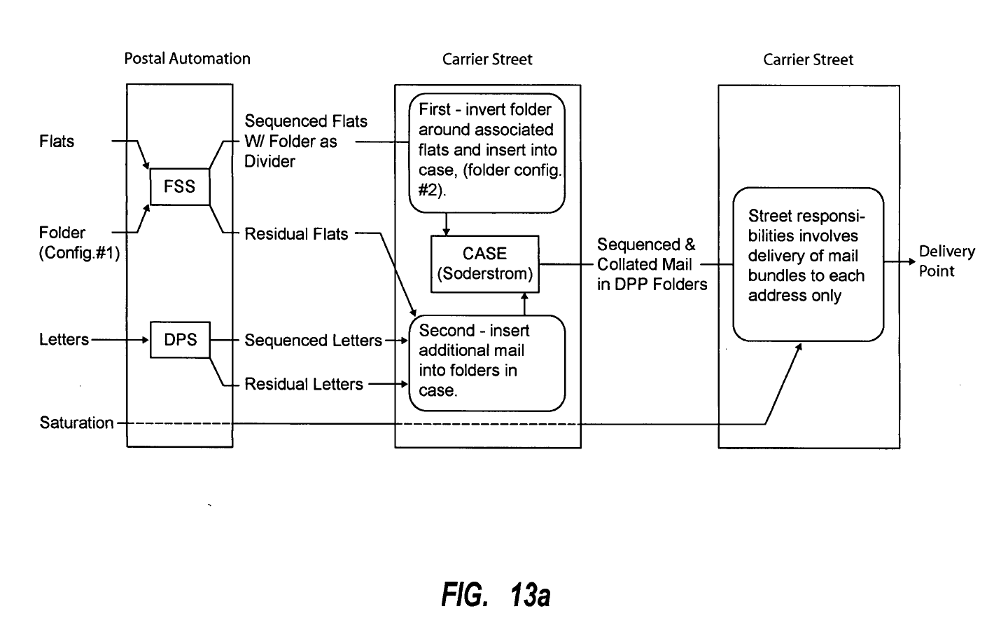

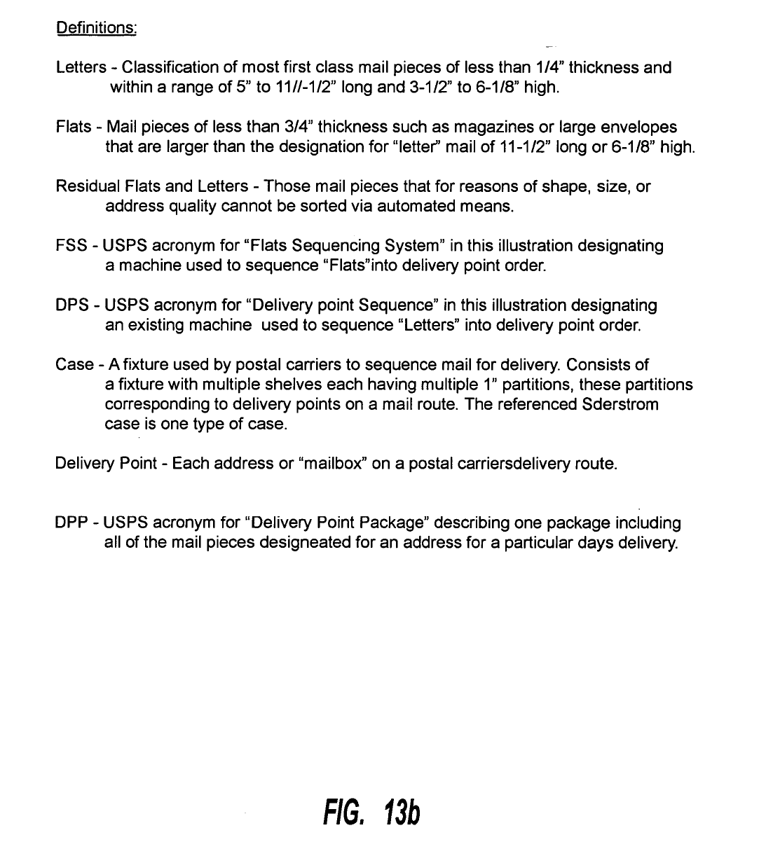

FIGS. 4 through 11 illustrate a folder 30 for use with the sorting device 10 that can accommodate current delivery methods of sequenced and residual letters, sequenced and residual flats and saturation mail shown in FIG. 12. The folder 30, however, can also be employed to enhance the mail delivery process by enabling the improved collation and delivery methods of the invention shown in FIG. 13 and described with respect to FIGS. 4-11.

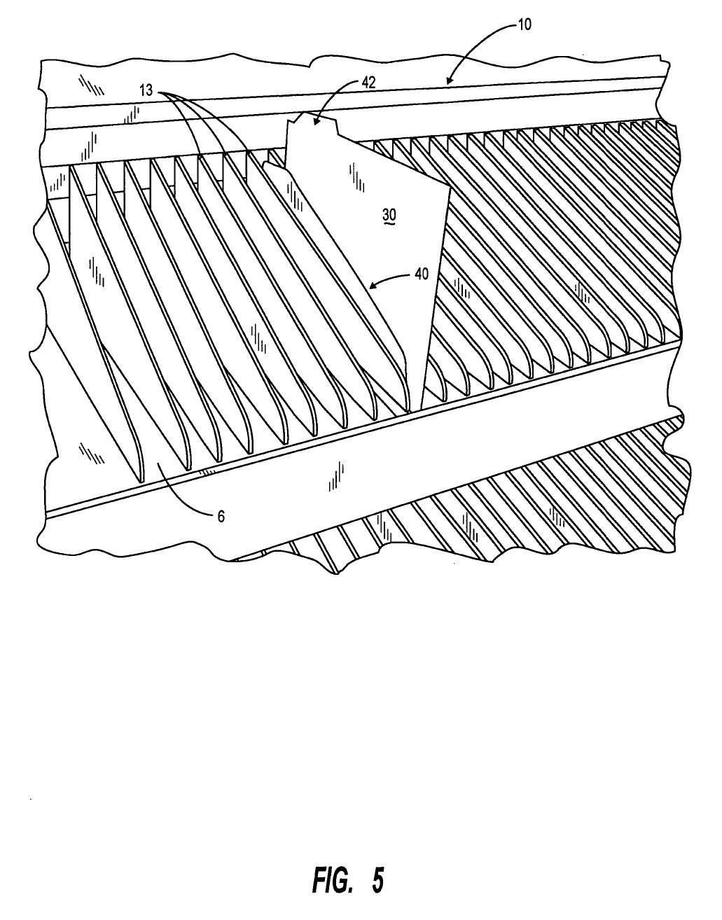

With attention to FIG. 4, the folder 30 is placed within a sorting compartment 14 in a splayed open condition for receiving the sorted items 32, such as mail. In the envisioned use, the folder 30 may be used in association with a particular address or location upon the sorting device 10 (defined between a pair of partitions 13) and receive the items 32 destined for that address. While only a single folder 30 is illustrated in FIGS. 5 and 6 in context with the sorting device 10, more than one folder 30 may be utilized in a sorting process. For a typical mail hold operation, relatively few folders 30 would be utilized. After the controlled felling operation, the one or more folders 30 may be removed from the sorted stack of mail for holding and subsequent delivery or redirection.

In another envisioned use, a folder 30 may be used within each of the sorting compartments 14 and used to separate the items 32 from adjacent compartments 14. In this manner, the folders 30 may provide discrete mail packets associated with each of the address locations. Yet another benefit of the folder 30 used in conjunction with the Soderstrom sorting device 10 is the facilitation of sorted document removal from between the partitions 13. Without use of the folder 30, and particularly with substantially full sorting compartments, some light documents may be suspended away from the drawer or bottom 6 and be frictionally held by the partition 13 walls as the drawer 6 is extended and be separated from the associated mail items. As an additional step, these separated items then need to be manually replaced within the sorted order of items. By placing a folder 30 in the compartment(s) 14 prior to the sorting process, items 32 can be inserted and held within the folder 30.

From the embodiment of FIG. 4, the folder 30 includes a configured sheet element 34. Sheet element 34 includes an exterior surface 36 suitable for receiving UPC, address, advertising or other indicia 38. Additional indicia 38 (e.g. UPC, address, advertising or other data etc.) may be included upon the interior surface of the sheet element 36. The address indicia 38 may include an addressee label or portion for receiving addressee information, UPC code, RFID strip or any other identification or information device, media or information. In one embodiment, the individual sheet elements 34 may be pre-printed with addressee information, stamped, and delivered as postage-paid mail by the carrier to the addressee. Sheet element 34 may include one or more transparent panels for revealing interior information. Sheet element 34 may include color coding or other color indicia for identifying particular routing information or address status (mail hold, redirect, etc.).

Sheet element 34 further includes a side reveal structure 40 which assists in the placement of mail with the folder 30 during a sorting operation. The side reveal structure 40 is shaped in relation to the leading edge 15 of the partitions 13 so that at least a portion of a folded side of the folder 30 does not extend vertically above the leading edge 15 of the partition 13. In the illustrated embodiment, the side reveal structure 40 is generally aligned with the leading edge 15 of the partitions 13 when placed in a sorting orientation in the sorting device 10 (See, FIG. 5). The mail carrier or other document handler is able to efficiently place mail into the folder 30 with a left-to-right hand motion passing over the reveal structure 40 and brought into contact with the opposite folded side wall of the sheet element 34 at which point the mail is released into the associated folder 30. As illustrated in FIGS. 5 and 6, the side reveal structure 40 is configured in relation to the angled front edge 15 of the partitions 13. The sheet element 34 also includes an upper tab element 42 for facilitating the identification of the folder 30 within the stack of sorted items 32.

Yet another feature of the folder 30 is a splay structure 44 which functions to retain the folder 30 in an open manner when placed between the partitions 13 of the sorting device 10. In one embodiment and as illustrated, the splay structure 44 includes a fold line 46 defined upon the folder 30. Alternative splay structures 44 may include multiple fold lines 46 or additional laminates of material disposed and arranged proximate the bottom portion of the folder 30 or other surfaces to define preferred folding orientations, resilience and memory characteristics to facilitate the sorting and preparation of each delivery point package (DPP).

Yet another possible splay structure 44 may include one or more fold lines 46 defined upon one side of the folder 30, with the folder 30 later inverted so that the fold line(s) bias the folder 30 opened. The folder 30 may be provided in a flat, stacked manner and inverted (e.g. inside surface folded out) just prior to inserting the folder 30 into the individual sorting compartments 14. Those skilled in the relevant arts may appreciate still other alternative splay structures 44 to cause the side walls of the folder 30 to diverge and converge in relation to each required orientation.

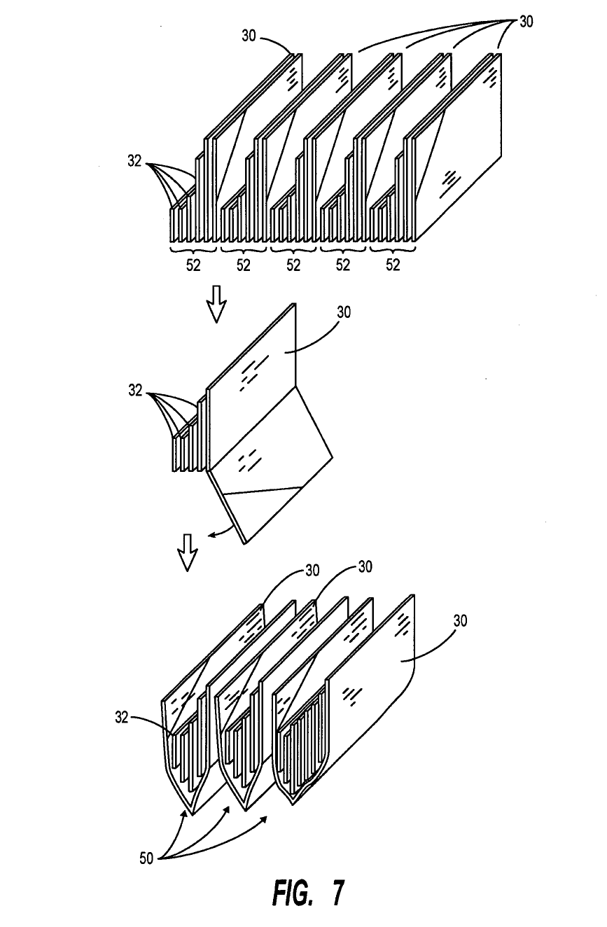

Referring now to FIG. 7, another aspect of the present invention is disclosed. In this embodiment, the folders 30 may be utilized as dividers within a mail sorting process used to create a delivery point package 50. The uppermost illustration of FIG. 7 represents a mail grouping which has been sorted, such as via a manual or automated process. Sub-groupings of sorted items 32 are depicted as numeral 52. Items 32 within the sub-groupings 52 are associated with a particular addressee or destination. Folder dividers 30 are provided within the sub-groupings 52 of items 32, such that the dividers 30 are adjacent two different sub-groupings 52. For example, the dividers 30 are disposed between two different addressees of sorted mail. The dividers 30 may have been processed via an automated sorting process or have been otherwise placed between the sub-groupings 52 of mail.

In one embodiment of the present invention, the dividers 30 are postage paid mailing items which are processed as regular mail items. In yet another embodiment, the dividers 30 include address specific information 38 and are sorted with reference to the information, but not otherwise being a postage carrying item. In the uppermost illustration of FIG. 7, each of the dividers 30 is placed in a predetermined relationship relative to the balance of the mail in each sub-grouping 52, i.e., the dividers 30 are disposed adjacent the right-most mail item 32 of the sub-grouping. Alternatively, the dividers 30 may be disposed adjacent the left-most mail item 32 of the sub-groupings 52. In either instance, the dividers 30 have been folded to a preferred condition, such as with the insides folded out.

As presented in the intermediate illustration of FIG. 7, the dividers 30 may be inverted to capture mail items 32 within the associated sub-grouping 52 with preferred surfaces of the folder walls oriented relative to subsequent processing steps. The inversion process may be a manual process by a mail sorter, or may be via an automated process. In an exemplary manual process, each sub-grouping 52 of mail 32 withdrawn from the stack sequenced mail has its folder 30 folded to its second orientation around the sub-grouping 52 to encompass the mail items 32. The sub-grouping 52 may comprise a DPP. A DPP may also contain more than one folder 30.

As presented in lower illustration FIG. 7, the process of divider 30 inversion captures the associated mail 32 and produces a delivery point package 50. The delivery point package 50 provides an efficient and effective mail item capture device which facilitates the delivery process by decreasing the effort required to identify all items to be delivered to an address and reducing the possibility of lost or separated mail items. In one embodiment, information 38 related to the associated mail may be printed on the surface of the inverted folder 30 to facilitate subsequent delivery of the delivery point package 52.

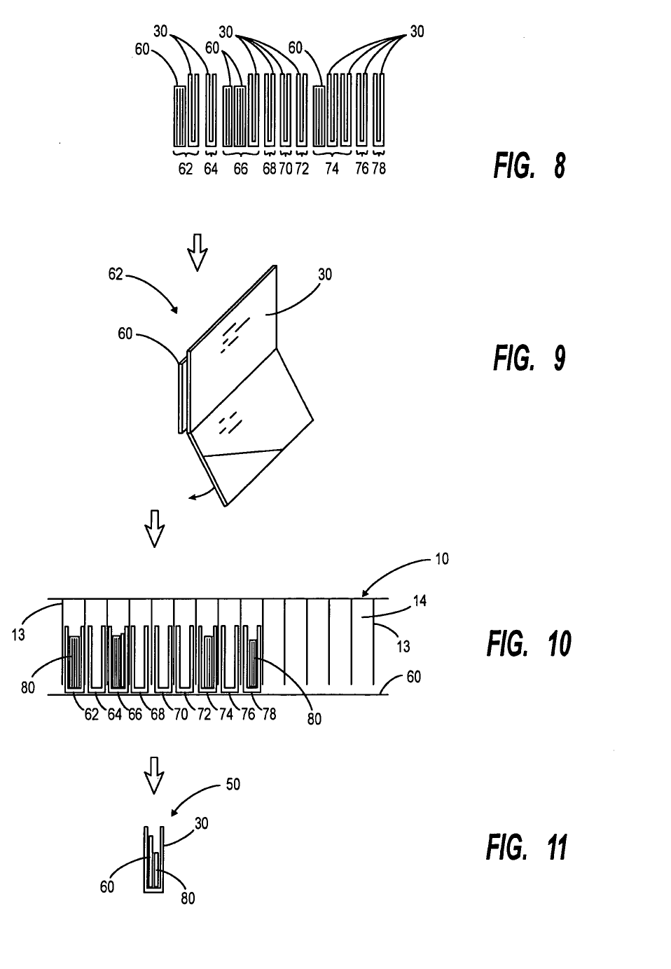

Referring now to FIGS. 8-11, another aspect of the present invention is disclosed. In this alternative embodiment, a hybrid automated/manual sorting process is envisioned. Particular application of this embodiment may include use within the United States Postal Service process, or other partially automated mail sorting systems. The USPS utilizes or is developing automated processes for delivery point sequencing of two categories of mail items; typical letter-sized items and larger mail items, commonly referred to as “flats”. The sorting processes for the two categories are achieved via two different automated sorting systems.

In the embodiment of FIGS. 8-11, the folders 30 may be utilized as dividers within a mail sorting process and to create another delivery point package 50. The mail sorting process may handle different categories of mail items differently, e.g., larger items may be sorted separately from smaller items, etc. FIG. 8 represents larger-sized mail items 60 that are less than ¾-inch thick, such as magazines, 9×12, 10×12 and 10×13 envelopes or any item generally larger than letter mail (i.e. 6⅛″ high×11½″ long) etc., commonly referred to as “flats” and folders 30 which have been sorted, such as via an automated process. Sub-groupings of sorted items 60 and folders 30 are depicted as numerals 62, 64, 66, 68, 70, 72, 74, 76, and 78. Items 60 within the sub-groupings 62, 64, 66, 68, 70, 72, 74, 76, and 78 and the folders 30 themselves are associated with a particular addressee or destination. As illustrated, some of the folders 30 will not have any associated “flats” but are otherwise placed in a sorted order via the automated “flats” sorting process. In one embodiment of the present invention, the dividers 30 are postage paid mailing items which are processed via the “flats” automated sorting process. In yet another embodiment, the dividers 30 include address specific information indicia 38 and are sorted with reference to the information, but not otherwise being a postage carrying item.

As presented in the illustration of FIG. 9, the dividers 30 may be inverted to capture the “flats” mail items 60 within the associated sub-grouping 52. The inversion process may be performed manually or with automated equipment.

As presented in illustration FIG. 10, the inverted dividers 30 may then be placed into a sorting device 10, such as the Soderstrom sorter, at which time additional “non-flats” and other mail items 80 may be inserted into the folder device 10. Upon inserting the additional items 80, including automatically sequenced letter mail (DPS) and “residual mail” (letters and flats which have not been run through automatic delivery point sequencing machines) the inverted dividers 30 holding all mail items 60, 80 can be withdrawn from the sorting device 10. Referring to FIG. 11, the process produces a delivery point package 50 for use described above.

FIG. 13 depicts a flow chart that demonstrates the collation and delivery process the USPS might experience when utilizing the folder device and Soderstrom sorter. The foregoing collation process(es) provides for one stack of sequenced and delivery point packaged mail. The packaged mail includes all mail types regardless of the collation/sequencing method. Optional saturation mailings contained on the delivery vehicle and intended for delivery to every address (shown in dashed line) can also be included with the sequenced packages prior to mail delivery. This process beneficially provides the advantage of greatly reducing the amount of time a carrier must spend on their delivery route by eliminating activities such as sorting, identifying breaks between address groupings, and collating multiple mail types before delivery.

With the loading of a delivery vehicle with a route's daily mail and appreciating that mail centers can collate mail differently, the delivery vehicle may be loaded with only sequenced DPP packages or may be loaded with multiple cases containing several types of delivery items. The non-DPP cases can contain independently collated sequenced flats and sequenced letters. Saturation mail (e.g. local advertising, fliers and geographically or customer specific pieces) may also be loaded into the vehicle. The delivery person immediately prior to delivery with the benefit of the DPP folders 30 is now able perform a final collation, if required no longer necessary with the implementation of the present invention. In this instance and as necessary, any associated sequenced flats or sequenced letters or saturation mail can be inserted into the DPP folders 30. The collection of all or substantially all the types of mail for each addressee destination into a common folder by the carrier facilitates handling as the mail is directed by the carrier from the delivery vehicle to a mailbox or is assembled and/or collected in a bag or other container used to deliver the mail to each delivery destination.

It will thus be seen that the objects set forth above, among those made apparent from the preceding description of the collation processes and folder constructions, can be achieved without departing from the contemplated spirit and scope of the invention. Various different combinations of the folders, delivery and collation processes may also be implemented to advantage in a variety of mail delivery systems. Still other objects, processes and mail delivery package constructions may also be apparent to those skilled in the art. The description should therefore be interpreted as only illustrative and not in a limiting sense. The following claims therefore are intended to cover all of the generic and specific features of the invention herein described.

What is claimed is:

1. A method of sorting mail, said method comprising the steps of:
providing a mail sorting device having a plurality of partition elements;
providing a plurality of invertable folder devices each having a pair of hinge connected sides between a plurality of pairs of partition elements;
placing said plurality of folder devices such that one side of each folder device abuts at least one partition element;
sorting a first collection containing a plurality of mail items into mail item sub-groupings contained between said pairs of partition elements and wherein each mail item within each sub-grouping includes similar destination indicia;
selecting each of said sub-groupings of mail items containing an associated folder device; and
inverting selected folder devices to capture the mail items within the selected sub-grouping between the sides of the inverted folder device to define a plurality of mail packages.

2. A method of claim 1 wherein at least one of the plurality of invertable folder devices comprises an addressed folder device containing addressee destination indicia disposed upon a surface thereof.

3. A method of claim 2 wherein the step of placing the folder devices includes the step of referencing the addressee destination indicia of the addressed folder devices and placing the addressed folder devices between partition elements having related destination indicia.

4. A method of claim 1 wherein the step of inverting the folder device to capture the associated sub-grouping of mail items is achieved via manual manipulation of the folder device.

5. A method of claim 1 wherein the step of inverting the folder device to capture the associated sub-grouping of mail items is achieved via an automated process.

6. A method of claim 1 wherein a folder device is placed between each pair of partition elements of said sorting device.

7. A method of claim 1 wherein at least one of said folder devices comprises an automatically sorted grouping of mail items containing addressee destination indicia common to a selected one of said sub-groupings.

8. A method of claim 1 wherein each of said partition elements comprises a planar member having top and bottom edges disposed parallel to a bottom wall of said sorting device, a vertical rear edge coupled to the top and bottom edges, a front edge rising from said bottom edge and a beveled edge projecting at an acute angle and intersecting said top edge, wherein one side of each of said folder devices comprises a rectangular planar member, wherein the other side of each of said folder devices comprises a planar member exhibiting a shape substantially identical to said partition elements, and wherein a beveled edge of the other side of said folder device coextensively aligns with the beveled edge of said partition element.

9. A method of claim 1 including the further steps of:
providing a second mail sorting device having a plurality of partition elements;
placing the inverted folders containing each of the first sub-groupings of mail items between a plurality of pairs of partition elements, such that each of the folder sides abuts an adjacent partition element;
accessing a second collection of mail items;
sorting the second collection of mail items and co-mingling the second collection of mail items into the folder devices having common addressee destination indicia to capture all mail items having common addressee destination indicia between the sides of the inverted folder devices to define a plurality of delivery point packages.

10. A method of claim 9 wherein the second collection of mail items includes a second plurality of folder devices associated by common destination indicia with the second collection of mail items such that at least one of said delivery point packages is comprised of a plurality of folder devices.

11. A method of claim 9 wherein each of said partition elements comprises a planar member having top and bottom edges disposed parallel to a bottom wall of said sorting device, a vertical rear edge coupled to the top and bottom edges, a front edge rising from said bottom edge and a beveled edge projecting at an acute angle and intersecting said top edge; and
wherein one side of each of said folder devices comprises a rectangular planar member that stands substantially above said partition elements, wherein the other side of each of said folder devices comprises a planar member exhibiting a shape substantially identical to said partition elements, and wherein a beveled edge of the other side of said folder device coextensively aligns with the beveled edge of said partition element;

12. A method of creating a delivery point package, said method comprising the steps of:
collating a plurality of mail items of a first category into a plurality of first sub-groupings, wherein the mail items of each of said first sub-groupings are each identified by a related destination indicia, and wherein each of said first sub-groupings contains a folder device having a pair of hinged sides;
providing a mail sorting device having a plurality of partition elements;
inverting each folder device to capture the first sub-groupings of mail items between the sides of each inverted folder device;
placing the folder devices containing each of said first sub-groupings between a pair of partition elements, such that each of the folder sides abuts one of the adjacent partition elements;
accessing a second category of mail items having similar destination indicia;
sorting and co-mingling the second category of mail items into the first sub-groupings having common addressee destination indicia to capture the first and second categories of mail items between the sides of the inverted folder devices to define a plurality delivery point packages.

13. A method of claim 12 wherein the step of inverting the folder devices to capture the first and second categories of mail items is achieved via manual manipulation of the folder device.

14. A method of claim 12 wherein the step of inverting the folder devices to capture the first and second categories of mail items is achieved via an automated process.

15. A method of claim 12 including the steps of
collecting the delivery point packages into a delivery container; and
placing additional mail items identified to at least one delivery point package into the associated folder device prior to delivery.

16. A method of claim 15 wherein the additional mail items are manually placed within the delivery point package immediately prior to delivery.

17. A method of using a sorting device, said method comprising the steps of:
providing a mail sorting device having a plurality of partition elements, wherein each of said partition elements comprises a planar member having top and bottom edges disposed parallel to a bottom wall of said sorting device, a vertical rear edge coupled to the top and bottom edges, a front edge rising from said bottom edge and a beveled edge projecting at an acute angle and intersecting said top edge;
providing a plurality of invertable folder devices each having a pair of hinge connected sides between a plurality of pairs of partition elements, wherein one side of each of said folder devices comprises a rectangular planar member that stands substantially above said partition elements, wherein the other side of each of said folder devices comprises a planar member exhibiting a shape substantially identical to said partition elements, and wherein a beveled edge of the other side of said folder device coextensively aligns with the beveled edge of said partition element;
placing said plurality of folder devices within said sorting device such that the beveled edge of the one side of each of said folder devices abuts the beveled edge of either the leftmost or rightmost adjacent partition element; and
sorting a plurality of mail items into mail item sub-groupings contained between said pairs of partition elements using the taller of said folder sides as a divider between each sub-grouping and wherein each mail item within each sub-grouping includes similar destination indicia, whereby the folder device captures the mail items within the selected sub-grouping between the sides of the folder device to define a delivery point package.

18. A method of creating delivery point packages for mail delivery, said method comprising the steps of:
sorting a plurality of mail items of a first category according to a plurality of unique destination indicia;
associating a folder device having a pair of hinge coupled sides with each unique destination indicia;
inverting each folder device to capture mail items associated with each unique destination indicia between the sides of the inverted folder device;
placing the inverted folder devices into a sorting machine having a plurality of partition elements;
inserting a plurality of mail items of a second category having common destination indicia into the inverted folder devices in the sorting machine; and
removing each of the inverted folder devices containing mail items of the first and second categories to define a plurality of delivery point packages.

19. A method of claim 18 wherein at least one of the plurality of invertable folder devices has addressee indicia disposed upon a surface thereof.

20. A method of claim 18 wherein the step of sorting a plurality of mail items from the first category is via an automated sorting process and wherein the process of inserting a plurality of mail items from the second category is a manual process.

21. A method of claim 18 wherein the step of inverting each folder device to capture associated mail items is achieved via manual manipulation of the folder device.

22. A method of claim 18 wherein the mail items of the first category include USPS designated flats and wherein the mail items of the second category include USPS designated non-flats.
